(19) United States
(12) Patent Application Publication
(10) Pub. No.: US 2004/0030088 A1
(43) Pub. Date: Feb. 12, 2004

(54) Acidic reducer for providing increased adhesion of a two component polyurethane primer to substrates

(75) Inventors: Keith L. Salter, Delta, OH (US); David L. Newton, Toledo, OH (US); Charleen K. Morrison, Liberty Center, OH (US)

Correspondence Address: BASF CORPORATION, ANNE GERRY SABOURIN, 26701 TELEGRAPH ROAD, SOUTHFIELD, MI, 48034-2442, US

(73) Assignee: BASF Corporation, Mount Olive, NJ (US)

(21) Appl. No.: 10/064,684

(22) Filed: Aug. 7, 2002

(51) Int. Cl. C08G 18/10

(52) U.S. Cl. 528/59

(57) ABSTRACT

A composition comprising a two component polyurethane composition comprising a first component comprising a polyisocyanate and a second component comprising a polyol, wherein at least one of the first component and the second component further comprise a solvent; a phosphoric acid; and a phosphate ester of the formula (OM)₃₋ₙ P(O)(OR)ₙ, wherein n is 1 or 2, R is an organofunctional group, and M is hydrogen, metal, or ammonium. Also, a composition comprising a two component polyurethane composition comprising a first component comprising a polyisocyanate and a second component comprising a polyol, wherein at least one of the first component and the second component further comprise a solvent, a phosphoric acid, and an epoxy resin. Also, methods of making the compositions.

### BACKGROUND OF INVENTION

As used herein, “automotive refinish” refers to compositions and processes used in the repair of a damaged automotive finish, usually an OEM provided finish. Refinish operations may involve the repair of one or more outer coating layers, the repair or replacement of entire automotive body components, or a combination of both. The terms “refinish coating” or “repair coating” may be used interchangeably.

Automotive refinishers must be prepared to paint a wide variety of materials. Examples of commonly encountered materials are one or more previously applied coatings, plastic substrates such as RIM, SMC and the like, and metal substrates such as aluminum, galvanized steel, and cold rolled steel. Bare metal and plastic substrates are often exposed as a result of the removal of the previously applied coating layers containing and/or surrounding the defect area. However, it is often difficult to obtain adequate adhesion of refinish coatings applied directly to exposed bare substrates.

Among the many factors influencing the degree of refinish coating/substrate adhesion are the type of exposed substrate, the presence or absence of adhesion promoting pretreatments and/or primers, the size of the exposed area to be repaired, and whether previously applied “anchoring” coating layers surround the exposed repair area.

For example, refinish adhesion is particularly challenging when the exposed substrate is a bare metal such as galvanized iron or steel, aluminum or cold rolled steel. It is especially hard to obtain adequate refinish adhesion to galvanized iron. “Galvanized iron or steel” as used herein refers to iron or steel coated with zinc. “Steel” as used herein refers to alloys of iron with carbon or metals such as manganese, nickel, copper, chromium, molybdenum, vanadium, tungsten and cobalt.

Refinish operations have traditionally used adhesion pretreatments to overcome the adhesion problems associated with the coating of bare metal substrates. Pretreatment, as used herein, may refer to either mechanical or chemical alterations of the bare metal substrate. Mechanical alterations used to obtain improved adhesion include sanding, scuffing, and the like. Chemical alterations include treatment of the substrate with compositions such as chromic acid conversion coatings, acid etch primers and the like.

Although such pretreatments have obtained improved refinish adhesion, they are undesirable for a number of reasons. Most importantly, pretreatments are inefficient and expensive to apply in terms of material, time, and/or labor costs. Some chemical pretreatments also present industrial hygiene and disposal issues. Finally, the use of some pretreatments such as acid etch primers may contribute to water sensitivity and/or coating failure under test conditions of extreme humidity.

Accordingly, it is highly desirable to provide a method of coating bare, untreated metal substrates that eliminates the step of applying one or more substrate pretreatments, especially a method useful in refinish operations.

In addition, adhesion to bare metal substrates is improved when the defect area to be repaired is relatively small and is surrounded by previously applied coating layers. Such previously applied coating layers act as an “adhesion anchor” to the refinish coating. However, many refinish repairs are of a size such that they lack any surrounding adhesion anchors. Moreover, such anchoring adhesion may be completely absent when replacement body parts are painted with a refinish coating.

Accordingly, it would be desirable to provide a method of refinishing a previously coated substrate wherein a coating could be applied to a bare, untreated metal substrate lacking any such “adhesion anchors” and desirable adhesion obtained.

Finally, improvements in refinish adhesion to bare exposed metal substrates must not be obtained at the expense of traditional refinish coating properties. Such properties include sandability, durability, ambient or low temperature cure, application parameters such as pot life, sprayability, and clean up, and appearance. Illustrative refinish coatings having such properties include urethane coatings, especially two component urethane coating.

Accordingly, it would be desirable to provide a method of refinishing a previously coated substrate, wherein a urethane based refinish coating having improved adhesion could be applied to bare, untreated metal substrates and desirable performance properties and refinish adhesion obtained.

### SUMMARY OF INVENTION

The present invention relates to a composition comprising a two component polyurethane composition comprising a first component comprising a polyisocyanate and a second component comprising a polyol, wherein at least one of the first component and the second component further comprise a solvent; a phosphoric acid; and a phosphate ester of the formula (OM)₃₋ₙ P(O)(OR)ₙ, wherein n is 1 or 2, R is an organofunctional group, and M is hydrogen, metal, or ammonium.

The present invention also relates to a method comprising providing a two component polyurethane composition comprising a first component comprising a polyisocyanate and a second component comprising a polyol; and adding a composition comprising an adhesion promoter in a solvent to at least one of the first component and the second component, wherein the adhesion promoter comprises a phosphoric acid and a phosphate ester of the formula (OM)₃₋ₙ P(O)(OR)ₙ, wherein n is 1 or 2, R is an organofunctional group, and M is hydrogen, metal, or ammonium; to form a coating composition.

The present invention also relates to a composition comprising a two component polyurethane composition comprising a first component comprising a polyisocyanate and a second component comprising a polyol, wherein at least one of the first component and the second component further comprise a solvent, a phosphoric acid, and an epoxy resin.

The present invention also relates to a method comprising: providing a two component polyurethane composition comprising a first component comprising a polyisocyanate and a second component comprising a polyol; and adding a composition comprising a solvent, a phosphoric acid, and an epoxy resin to at least one of the first component and the second component to form a coating composition.

### DETAILED DESCRIPTION

As used throughout, ranges are used as a shorthand for describing each and every value that is within the range. Any value within the range can be selected as the terminus of the range.

A method is provided for adding an adhesion promoter in a solvent to a two component urethane to form a coating composition. The adhesion promoter comprises a phosphate ester and phosphoric acid.

The phosphate ester has the formula (OM)₃₋ₙ P(O)(OR)ₙ, wherein n is 1 or 2, R is an organofunctional group, and M is hydrogen, metal, or ammonium. The OM group (s) of the phosphate ester form a chemical bond with the substrate via an acid base reaction with the acidic proton, and the OR group(s) interact with the polyurethane. The phosphate ester becomes a chemical bridge to provide increased adhesion. Preferably R is a saturated or unsaturated C₅-C₄₀ aliphatic group in which one or more of the aliphatic carbon atoms can be substituted or replaced with a halogen atom (such as fluorine or chlorine), a C₁-C₆ alkyl group, a C₁-C₆ alkoxy group, a C₆-C₁₀ aromatic hydrocarbon group, preferably phenyl or naphthyl, or a C₆-C₁₀ aromatic hydrocarbon group that is substituted with one or more (preferably 1 to 3) C₁-C₆ alkyl groups or —COOR¹ groups wherein R¹ is H, metal, ammonium, C₁-C₆ alkyl, or C₆-C₁₀ aryl, or mixtures thereof.

In preferred compounds phosphate esters, R will contain one or more C₆-C₁₀ aromatic hydrocarbon groups, and most preferably, one or more C₆-C₁₀ aromatic hydrocarbon groups that contain one or more, preferably at least two, —COOR¹ groups, wherein R¹ is H, metal, ammonium, C₁-C₆ alkyl, or C₆-C₁₀ aryl. In a most preferred phosphate ester, R will contain at least one C₆-C₁₀ aromatic hydrocarbon group and at least two —COOR¹ groups wherein R¹ is H, metal, ammonium, C₁-C₆ alkyl, or C₆-C₁₀ aryl. R¹ will most preferably be a C₁-C₆ alkyl or a C₆-C₁₀ aryl group.

The —COOR¹ groups may be lateral or terminal. It will be appreciated that when R¹ is H, the phosphate ester will comprise one or more free carboxylic acid groups. Similarly, when R¹ is a metal or ammonium ion, the phosphate ester will have one or more carboxylic acid salt groups. Finally, when R¹ is a C₁-C₆ alkyl or a C₆-C₁₀ aryl, the phosphate ester will comprise one or more ester groups.

Preferred phosphate esters are those available from Lubrizol Corp. of Wickliffe, Ohio, and are available as LUBRIZOL™ 2061, LUBRIZOL™ 2062, and LUBRIZOL™ 2063.

The adhesion promoter can etch the substrate and can obtain at least some complexing (phosphidazation) with the substrate. The adhesion promoter is added in an amount sufficient to etch the substrate. Preferably, the phosphate ester is present in the composition in an amount ranging from about 0.1% to about 5% based on the total solids weight of the composition, and the phosphoric acid is present in the composition in an amount ranging from about 0.1% to about 4% based on the total solids weight of the composition. More preferably, the phosphate ester is present in the composition in an amount ranging from about 0.7% to about 1.5% based on the total solids weight of the composition, and the phosphoric acid is present in the composition in an amount ranging from about 0.5% to about 1.2% based on the total solids weight of the composition.

The solvent can be any solvent that is non chemically reactive with isocyanates, and preferably the solvent is acid solubilizing. Generally, in order to be able to solubilize an acid, such as phosphoric acid, the solvent has a hydrophilic character. Preferred solvents include, but are not limited to, ketones and propylene glycol monomethyl ether acetate. A preferred solvent is a blend of acetone with methyl ethyl ketone. The amount of acetone in a preferred blend ranges from about 30% to 100% by weight. In a preferred blend, acetone is 90% and MEK is 10% by weight. Additionally, the solvent can contain water in an amount that is sufficient to aid acid solubilization.

Polyurethanes are also well-known in the art. They are prepared by a chain extension reaction of a polyisocyanate (e.g., hexamethylene diisocyanate, isophorone diisocyanate, MDI, etc.) and a polyol (e.g., 1,6-hexanediol, 1,4-butanediol, neopentyl glycol, trimethylol propane). They can be provided with active hydrogen functional groups by capping the polyurethane chain with an excess of diol, polyamine, amino alcohol, or the like.

Although polymeric or oligomeric active hydrogen components are often preferred, lower molecular weight non-polymeric active hydrogen components may also be used in some applications, for example aliphatic polyols (e.g., 1,6-hexane diol), hydroxylamines (e.g., monobutanolamine), and the like.

Suitable isocyanate functional compounds include polyisocyanates which are aliphatic, including cycloaliphatic polyisocyanates, or aromatic polyisocyanates. Useful aliphatic polyisocyanates include aliphatic diisocyanates such as ethylene diisocyanate, 1,2-diisocyanatopropane, 1,3-diisocyanatopropane, 1,6-diisocyanatohexane, 1,4-butylene diisocyanate, lysine diisocyanate, hexamethylene diisocyanate (HDI), 1,4-methylene bis-(cyclohexylisocyanate) and isophorone diisocyanate. Useful aromatic polyisocyanates include the various isomers of toluene diisocyanate, meta-xylenediioscyanate and para-xylenediisocyanate, also 4-chloro-1,3-phenylene diisocyanate, 1,5-tetrahydro-naphthalene diisocyanate, 4,4′-dibenzyl diisocyanate and 1,2,4-benzene triisocyanate can be used. In addition, the various isomers of α, α, α′, α′-tetramethyl xylene diisocyanate can be used.

In addition to the polyurethane polymer, the composition can further comprise an epoxy resin. Preferred epoxy resins include, but are not limited to, BECKOPOX™ EM-460 from Solutia, Inc., St. Louis, Mo. The epoxy resin further increases the adhesion of a coating made from the coating composition to a substrate. The epoxy resin can react with remaining acid to reduce the effect of the acid on water sensitivity. Preferably the epoxy resin is added to the composition in an amount sufficient to react with the remaining acid. Preferably, the epoxy resin is present in an amount ranging from about 0.8% to about 15.0% based on the total solids weight of the composition. In a preferred embodiment, the epoxy resin is present at 5.9% by weight.

The adhesion of the two component polyurethane coating to the substrate can be increased up to 100% or more over the same coating without the adhesion promoter as measured by Ford test FLTM B1 104-01. The test ranks adhesion loss on a scale from 0 (no adhesion loss) to 10 (100%) adhesion loss.

Additionally, the coating composition can include any other material that is added to coating compositions. Examples of other materials include, but are not limited to, crosslinking agents, fillers, solvents, coloring agents, driers, corrosion inhibitors, rheology control agents, mar/slip additives, wetting agents, dispersing agents, light stabilizers, adhesion promoters, pH adjusting agents, catalysts, and flow control additives. Each of these other materials can be used in any amount that is used by one of ordinary skill in the art to prepare coating compositions.

Examples of fillers include, but are not limited to, clays, talc, calcium carbonate, diatomaceous earth, mica, kaolin, barium sulfate, magnesium carbonate, fumed silica, vermiculite, graphite, alumina, silica, and rubber powder. Coloring agents such as titanium dioxide and carbon black can also be used as the fillers.

The solvents can be any solvent that is supplied as a component in any of the other materials that are added to the coating composition.

Examples of coloring agents include, but are not limited to, color pigments, effect pigments, color and effect pigments, and dyes. Various organic pigments and inorganic pigments may be broadly used as the coloring agents, but non-toxic anticorrosive pigments are preferred. Examples of such pigments are phosphate-type anticorrosive pigments such as zinc phosphate, calcium phosphate, aluminum phosphate, titanium phosphate, silicon phosphate, and ortho—and fused phosphates of these; molybdate-type anticorrosive pigments such as zinc molybdate, calcium molybdate, calcium zinc molybdate, potassium zinc molybdate, potassium zinc phosphomolybdate and potassium calcium phosphomolybdate; and borate-type anticorrosive pigments such as calcium borate, zinc borate, barium borate, barium meta-borate and calcium meta-borate.

Examples of rheology control agents include, but are not limited to, organo clays, hydrogenated caster oils, silica gels, polyvinyl alcohol, cellulose derivatives such as hydroxyethyl cellulose, hydroxypropyl cellulose and carboxymethyl cellulose salt, polyether compounds, urethane modified polyether compounds, polycarboxylic acid compounds, sodium salts of polycarboxylic compounds, polyvinylpyrrolidone, polyoxyethylene derivatives such as polyethylene glycol ether and polyethylene glycol distearate, sodium alginate and inorganic materials such as sodium silicate and bentonite.

Examples of mar/slip additives include, but are not limited to, silicones, micronized waxes, polyesters, and fluoro-surfactants.

Examples of wetting agents include, but are not limited to, fatty acid salts, multifunctional urethanes, and polyalkyl ethers.

The dispersing agents include, but are not limited to, inorganic dispersing agents such as sodium salts of polycarboxylic acids, sodium or ammonium salts of fused naphthalene sulfonate, polyoxyalkylene alkyl ethers of phenol ether, sorbitan fatty acid esters, polyoxyalkylene fatty acid esters, glycerin fatty acid esters, polyoxyethylene styrene phenol, sodium tripolyphosphate and sodium hexametaphosphate. Organosilanol derivatives of tung oil, or linseed oil, or high erucic acid rapeseed oil that are useful as surfactants are also suitable as dispersing agents.

Examples of adhesion promoters include, but are not limited to, phosphate esters, silanes, (meth)acrylic acid, metal salts of (meth)acrylic acid, vinyl phosphonic acid, vinyl sulfonic acid, 2-acrylamido-2-methyl propane sulfonic acid, carboxylic acid functional (meth)acrylates, (meth)acrylate functional urethane monomers, (meth) acrylate functional urethane oligomers, and the direct to metal additives described in U.S. Ser. No. 09/599,693 filed on Jun. 22, 2000, which is incorporated herein by reference.

Examples of pH adjusting agents included, but are not limited to, sodium hydroxide, potassium hydroxide, sodium hydrogen carbonate, ammonium hydroxide, ammonia, amines, triethanolamine, and 3-dimethylaminoethanol.

Examples of catalysts include, but are not limited to, dibutyltin dilaurate, dibutyltin diacetate, dibutlytin dichloride, dibutyltin dibromide, dibutyltin bis(2-ethylhexanoate), and other known catalysts for reactions of isocyanates and or epoxy functional materials.

Examples of flow control additives include, but are not limited to, acrylic resins, silicones, and fluorocarbons.

The coating composition of the present invention can be applied to a substrate by any method known in the art. Application methods include, but are not limited to, brushing, wiping, roller-coating, dipping, flow coating, and spraying. Once applied, the coating composition is formed into a coating by allowing the coating composition to air dry, oven dry, bake, or combinations thereof.

Substrates that can be coated with the coating composition of the present invention include, but are not limited to, metal, plastic, wood, wall board, plaster, glass, and ceramics. The present invention is particularly useful when the coating composition is applied directly to metal. Metals include, but are not limited to, steel, galvanized steel, iron, galvanized iron, aluminum, aluminum alloy, zinc, zinc alloy plated steel, cold rolled steel, titanium, titanium alloy, cadmium, and magnesium.

In one embodiment, the coating composition can be used as an automotive refinish. As used herein, “automotive refinish” refers to compositions and processes used in the repair of a damaged automotive finish, usually an OEM provided finish. Refinish operations may involve the repair of one or more outer coating layers, the repair or replacement of entire automotive body components, or a combination of both. The terms “refinish coating” or “repair coating” may be used interchangeably.

The invention is further described in the following examples. The examples are merely illustrative and do not in any way limit the scope of the invention as described and claimed. The test methods used in the examples are adhesion loss after 10-days water immersion according to Ford test FLTM B1 104-01.

### EXAMPLE 1

A primer composition was prepared by mixing 4 gallons of 285-50 primer from BASF Corporation, 1 gallon of 929-83 hardener from BASF Corporation, 1 gallon of modified VR29 reducer, and 0.045 gallons of an 85% phosphoric acid. The 1-gallon of modified VR29 reducer was a mixture by weight of 92.7% VR29 Reducer from BASF Corporation, 2.5% (85%) phosphoric acid, and 4.8% LUBRIZOL™ 2063 phosphate ester. The primer composition was applied to a galvanized panel. The panel sat overnight before being sanded and cleaned with 541-5 cleaner from BASF Corporation. A basecoat, 55-Line from BASF Corporation, made from 10 parts 55 line white basecoat, 1 part 355-55 hardener, and 4 parts 352-91 reducer (all available from BASF Corporation) was applied over the primer and air dried for a half hour. A clearcoat composition made from 2 parts DC-98 clearcoat, 1 part 929-23 hardener, and 10% 352-91 reducer (all available from BASF Corporation) was applied over the basecoat. The panel was allowed to set for 4 days, and then the panel was baked at 60° C. (140° F.) for 1 hour. The panel had an initial adhesion loss of 0 at initial testing and 0 after 10 days water immersion.

### EXAMPLE 2

A primer composition was prepared by mixing 4 gallons of 285-50 primer from BASF Corporation, 1 gallon of 929-85 hardener from BASF Corporation, 1 gallon of PNT62 reducer from BASF Corporation, 0.045 gallon of an 85% phosphoric acid, and 0.37 gallon of BECKOPOX™ EM-460 epoxy resin. There was no phosphate ester used in this composition. The BECKOPOX™ EM-460 epoxy resin was first mixed with the 285-50 primer, and the phosphoric acid was first mixed with the PNT62 reducer. Then the primer, hardener, and the reducer were all mixed together. The primer composition was applied to a galvanized panel. The panel sat overnight before being sanded and cleaned with 541-5 cleaner from BASF Corporation. A basecoat, 55-Line from BASF Corporation, made from 10 parts 55 line white basecoat, 1 part 355-55 hardener, and 4 parts 352-91 reducer (all available from BASF Corporation) was applied over the primer and air dried for a half hour. A clearcoat composition made from 2 parts DC-98 clearcoat, 1 part 929-23 hardener, and 10% 352-91 reducer (all available from BASF Corporation) was applied over the basecoat. The panel was allowed to set for 4 days, and then the panel was baked at 60° C. (140° F.) for 1 hour. The panel had an initial adhesion loss of 0 at initial testing and 2 after 10 days water immersion.

A control was prepared with 4 gallons of 285-50 primer from BASF Corporation, 1 gallon of 929-83 hardener, and 1 gallon of 352-91 reducer. The primer composition was applied to a galvanized panel. The panel sat overnight before being sanded and cleaned with 541-5 cleaner from BASF Corporation. The basecoat from above was applied over the primer, and the panel air dried for a half hour. The clearcoat from above was applied over the basecoat. The panel was allowed to set for 4 days, and then the panel was baked at 60° C. (140° F.) for 1 hour. The panel had initial adhesion loss of 10 (total removal) and 10 after 10 days water immersion.

Another control was prepared like the previous control, except that the clearcoat used was 3 parts of R-M® DC92 clearcoat, 1 part DH 46 hardener, and 20% UR50 reducer (all available from BASF Corporation). The panel had initial adhesion loss of 6 (60% removed) and 3 (30% removal) after 10 days.

The above results show that when the inventive phosphate ester and phosphoric acid are included in a coating composition, the adhesion loss of the coating is less than when the phosphate ester and the phosphoric acid are not included in the composition.

It should be appreciated that the present invention is not limited to the specific embodiments described above, but includes variations, modifications and equivalent embodiments defined by the following claims.

1. A composition comprising a two component polyurethane composition comprising a first component comprising a polyisocyanate and a second component comprising a polyol, wherein at least one of the first component and the second component further comprise a solvent; a phosphoric acid; and a phosphate ester of the formula (OM)₃₋ₙP(O)(OR)ₙ, wherein n is 1 or 2, R is an organofunctional group, and M is hydrogen, metal, or ammonium.

2. The composition of claim 1 further comprising an epoxy resin.

3. The composition of claim 1 further comprising an epoxy resin in an amount ranging from about 0.8% to about 15% based on a total solids weight of the composition.

4. The composition of claim 1, wherein the phosphate ester is added in an amount ranging from about 0.1% to about 5% based on a total solids weight of the composition, the phosphoric acid is added in an amount ranging from about 0.1% to about 4% based on a total solids weight of the composition.

5. The composition of claim 1, wherein the solvent is non chemically reactive with isocyanates and is able to solubilize phosphoric acid.

6. The composition of claim 1, wherein the solvent comprises at least one of a ketone and propylene glycol monomethyl ether acetate.

7. The composition of claim 1, wherein the solvent comprises acetone and methyl ethyl ketone.

8. The composition of claim 1, wherein the solvent comprises acetone and methyl ethyl ketone, and wherein the amount of acetone ranges from about 30% to less than 100% by weight of the solvent.

9. The composition of claims 1, wherein the solvent further comprises water.

10. The composition of claim 1, wherein R is at least one of a saturated C₅-C₄₀ aliphatic group; an unsaturated C₅-C₄₀ aliphatic group; a substituted, saturated C₅-C₄₀ aliphatic group; and a substituted, unsaturated C₅-C₄₀ aliphatic group; wherein the substituting group substitutes at least one of the aliphatic carbon atoms, and wherein the substituting group is at least one of i) a halogen atom; ii) a C₁-C₆ alkyl group; iii) a C₁-C₆ alkoxy group; iv) a C₆-C₁₀ aromatic hydrocarbon group; and v) a C₆-C₁₀ aromatic hydrocarbon group that is substituted with at least one of a C₁-C₆ alkyl group and —COOR¹ group, wherein R¹ is at least one of H, metal, ammonium, C₁-C₆ alkyl, and C₆-C₁₀ aryl.

11. The composition of claim 1, wherein the composition is a coatings primer composition.

12. A method comprising applying the composition of claim 1 to a substrate and forming a coating on the substrate.

13. A method for making the composition of claim 1 comprising: providing the two component polyurethane composition; and adding the composition comprising the adhesion promoter in the solvent to at least one of the first component and the second component to form a coating composition.

14. The method of claim 13 further comprising adding an epoxy resin to at least one of the first component and the second component.

15. The method of claim 13 further comprising adding an epoxy resin to at least one of the first component and the second component in an amount ranging from about 0.8% to about 20% based on a total solids weight of the coating composition.

16. The method of claim 13, wherein the phosphate ester is added in an amount ranging from about 0.1% to about 5% based on a total solids weight of the coating composition, the phosphoric acid is added in an amount ranging from about 0.1% to about 4% based on a total solids weight of the coating composition.

17. The method of claim 13, wherein the solvent is non chemically reactive with isocyanates and is able to solubilize phosphoric acid.

18. The method of claim 13, wherein the solvent comprises at least one of a ketone and propylene glycol monomethyl ether acetate.

19. The method of claim 13, wherein the solvent comprises acetone and methyl ethyl ketone.

20. The method of claim 13, wherein the solvent comprises acetone and methyl ethyl ketone, and wherein the amount of acetone ranges from about 30% to less than 100% by weight of the solvent.

21. The method of claim 13, wherein the solvent further comprises water.

22. The method of claim 13, wherein R is at least one of a saturated C₅-C₄₀ aliphatic group; an unsaturated C₅-C₄₀ aliphatic group; a substituted, saturated C₅-C₄₀ aliphatic group; and a substituted, unsaturated C₅-C₄₀ aliphatic group; wherein the substituting group substitutes at least one of the aliphatic carbon atoms, and wherein the substituting group is at least one of i) a halogen atom; ii) a C₁-C₆ alkyl group; iii) a C₁-C₆ alkoxy group; iv) a C₆-C₁₀ aromatic hydrocarbon group; and v) a C₆-C₁₀ aromatic hydrocarbon group that is substituted with at least one of a C₁-C₆ alkyl group and —COOR¹ group, wherein R¹ is at least one of H, metal, ammonium, C₁-C₆ alkyl, and C₆-C₁₀ aryl.

23. The method of claim 13 further comprising applying the coating composition to a substrate and forming a coating on the substrate.

24. The method of claim 13, wherein the coating composition is a coatings primer.

25. A composition comprising a two component polyurethane composition comprising a first component comprising a polyisocyanate and a second component comprising a polyol, wherein at least one of the first component and the second component further comprise a solvent, a phosphoric acid, and an epoxy resin.

26. The composition of claim 25, wherein the phosphoric acid is present in the composition in an amount ranging from about 0.1% to about 4% based on the total solids weight of the composition.

27. The composition of claim 25, wherein the epoxy resin is present in an amount ranging from about 0.8% to about 15.0% based on the total solids weight of the corn position.

28. The composition of claim 25, wherein the solvent is non chemically reactive with isocyanates and is able to solubilize phosphoric acid.

29. The composition of claim 25, wherein the solvent comprises at least one of a ketone and propylene glycol monomethyl ether acetate.

30. The composition of claim 25, wherein the solvent comprises acetone and methyl ethyl ketone.

31. The composition of claim 25, wherein the solvent comprises acetone and methyl ethyl ketone, and wherein the amount of acetone ranges from about 30% to less than 100% by weight of the solvent.

32. The composition of claim 25, wherein the solvent further comprises water.

33. The composition of claim 25, wherein the composition is a coatings primer composition.

34. A method comprising applying the composition of claim 25 to a substrate and forming a coating on the substrate.

35. A method for making the composition of claim 25 comprising: providing the two component polyurethane composition; and adding the composition comprising the solvent, the phosphoric acid, and the epoxy resin to at least one of the first component and the second component to form a coating composition.

36. The method of claim 35, wherein the phosphoric acid is present in the composition in an amount ranging from about 0.1% to about 4% based on the total solids weight of the composition.

37. The method of claim 35, wherein the epoxy resin is present in an amount ranging from about 0.8% to about 15.0% based on the total solids weight of the composition.

38. The method of claim 35, wherein the solvent is non chemically reactive with isocyanates and is able to solubilize phosphoric acid.

39. The method of claim 35, wherein the solvent comprises at least one of a ketone and propylene glycol monomethyl ether acetate.

40. The method of claim 35, wherein the solvent comprises acetone and methyl ethyl ketone.

41. The method of claim 35, wherein the solvent comprises acetone and methyl ethyl ketone, and wherein the amount of acetone ranges from about 30% to less than 100% by weight of the solvent.

42. The method of claim 35, wherein the solvent further comprises water.

43. The method of claim 35, wherein the coating composition is a coatings primer.
